(19) United States
(12) Patent Application Publication
(10) Pub. No.: US 2013/0151509 A1
(43) Pub. Date: Jun. 13, 2013

(54) SYSTEM AND METHOD FOR GRAPHICAL DISPLAY OF SEARCH RESULTS

(71) Applicant: SPIRORITY, INC., Sunnyvale, CA (US)

(72) Inventor: Phuong L. Tran, Sunnyvale, CA (US)

(73) Assignee: SPIRORITY, INC., Sunnyvale, CA (US)

(21) Appl. No.: 13/674,069

(22) Filed: Nov. 11, 2012

Related U.S. Application Data
(60) Provisional application No. 61/569,781, filed on Dec. 12, 2011.
(60) Provisional application No. 61/595,675, filed on Feb. 6, 2012.

(51) Int. Cl. G06F 17/30

(52) U.S. Cl. CPC G06F 17/30554
USPC 707/723

(57) ABSTRACT

A graphical display of objects by a computer system comprises receiving a plurality of objects for display to a user; presenting for display on a display screen of an electronic device a plurality of sets of frames in increasingly smaller radial patterns, wherein after a first set of frames, each successive set of frames is nested within an immediately preceding set of frames; and presenting for display in the sets of frames at least a portion of the objects to form nested radial arrays of objects.

### CROSS-REFERENCE TO RELATED APPLICATIONS

This application claims the benefit of provisional Patent Application Ser. No. 61/569,781, filed Dec. 12, 2011, and provisional Patent Application Ser. No. 61/595,675, filed Feb. 6, 2012, both incorporated herein by reference.

### BACKGROUND

When a user accesses the Internet and conducts a search, the search results are typically presented as a plurality of textual descriptions arranged as a column in list form. Often, the user wishes to obtain more information about a particular web site retrieved in the search, beyond the brief description provided in such a column of results. The additional information desired may be available only in the home page of the web site of interest.

To access the home page information, the user may take the extra step of connecting to the home page by selecting and “clicking” on the appropriate hyperlink in the list of search results. If the information so obtained is not satisfactory, the user may need to return to the descriptions in the search results, and select another hyperlink to view another home page. This process may be repeated a number of times before the user has obtained the information sought for.

It can be further appreciated that only a select few search result “hits” appear in the user column of listing descriptions at any one time. If the user wishes to view succeeding or preceding search results in another column, it may be necessary to navigate forward or backward from the current search results page being presented on the user display device. What is needed is a method and system for displaying home page information for web sites retrieved in an Internet search, without requiring a user to navigate back and forth between a textual summary of found sites, and the respective home pages.

### BRIEF SUMMARY

The exemplary embodiment provides methods and systems for the graphical display of objects by a computer system. Aspects of exemplary environment include receiving a plurality of objects for display to a user; presenting for display on a display screen of an electronic device a plurality of sets of frames in increasingly smaller radial patterns, wherein after a first set of frames, each successive set of frames is nested within an immediately preceding set of frames; and presenting for display in the sets of frames at least a portion of the objects to form nested radial arrays of objects.

[Optional statement of advantages] According to the method and system disclosed herein, the exemplary embodiment . . . .

### BRIEF DESCRIPTION OF SEVERAL VIEWS OF THE DRAWINGS

FIG. 1 is a block diagram illustrating an exemplary system environment in which one embodiment of the present invention may be implemented;

FIG. 2 is a flow diagram illustrating one embodiment of a process for graphical display of objects on an electronic device in a radial array;

FIG. 3 is a diagram showing a collection of objects representing initial user search results displayed as a plurality of search result frames configured into a circular array in accordance with one embodiment;

FIG. 4 is a diagrammatical illustration of user additional search results displayed as a second plurality of search result frames in a circular configuration nested inside the initial search results of FIG. 3;

FIG. 5 is a pictorial illustration of a user search result session displayed as a plurality of search result frames arrayed in a configuration of nested circles, in accordance with the present invention;

FIG. 6 is a diagrammatical illustration of user initial search results displayed as a plurality of search result frames arrayed in an elliptical configuration, in accordance with the present invention;

FIG. 7 is a diagrammatical illustration of user initial search results displayed as a plurality of search result frames arrayed in a spiral configuration, in accordance with the present invention;

FIG. 8 is a diagrammatical illustration of user additional search results displayed as a second plurality of search result frames in an elliptical configuration nested inside the initial search results of FIG. 3;

FIG. 9 is a pictorial illustration of user search results displayed as a plurality of search result frames arrayed in a spiral configuration, in accordance with the present invention;

FIG. 10 is a diagrammatical illustration of user initial search results displayed as a plurality of search result frames arrayed in an elliptical spiral configuration, in accordance with the present invention;

FIG. 11 is a diagrammatical illustration of frame selection from the search results of FIGS. 5, 9, and 10, showing selected frames brought forward and oriented for viewing, with the array of search result frames tilted away from the user;

FIG. 12 is a diagrammatical illustration of generic frames in a spiral configuration, in which the frames are populated with search results and arranged in a ranking order, according to criteria selected by the user;

FIG. 13 is a pictorial illustration of the search result frames arrayed in a configuration of nested circles, of FIG. 5, modified for use in a display screen having a square or round configuration;

FIG. 14 is a pictorial illustration of the search result frames, of FIG. 5, arrayed in a configuration of nested circles modified for use on a foldable screen.

FIG. 15 is a pictorial illustration of two sets of search result frames arrayed in a central panel of two nested circles, flanked by two search box panels;

FIG. 16 is a pictorial illustration of a search panel and two sets of search result frames arrayed in a central panel of two nested circles, flanked by second and third search panels;

FIG. 17 is a pictorial illustration of a four sets of search result frames as may be adapted for use in a classroom setting;

FIG. 18A is a pictorial illustration of search result frames arrayed about a three dimensional spherical globe surface, the frames providing operational menus for operation of the interior globe;

FIG. 18B is a pictorial illustration of the search result frames of FIG. 18A providing operational menus for operation of the interior globe;

FIG. 19 is a pictorial illustration of objects displayed in an outer set of frames of the radial array, while content about the objects is displayed in an inner region of the radial array.

FIG. 20 is a diagrammatical illustration of search result frames showing the three rankings of a particular web page found using three different search engines;

FIG. 21 is a pictorial illustration of the search result frames of FIG. 20;

FIG. 22 is a diagrammatical illustration of search result frames indicating the same web page found using two different search engines;

FIG. 23 is a diagram illustrating an example in which the user has input a search term “travel” into a browser's search field.

FIG. 24 is a diagram illustrating the radial array combined with a horizontal slider displaying images, and an iframe displaying text content adjacent to the radial array.

### DETAILED DESCRIPTION

The exemplary embodiment relates to the graphical display of objects by a computer system. The following description is presented to enable one of ordinary skill in the art to make and use the invention and is provided in the context of a patent application and its requirements. Various modifications to the exemplary embodiments and the generic principles and features described herein will be readily apparent. The exemplary embodiments are mainly described in terms of particular methods and systems provided in particular implementations. However, the methods and systems will operate effectively in other implementations. Phrases such as “exemplary embodiment”, “one embodiment” and “another embodiment” may refer to the same or different embodiments. The embodiments will be described with respect to systems and/or devices having certain components. However, the systems and/or devices may include more or less components than those shown, and variations in the arrangement and type of the components may be made without departing from the scope of the invention. The exemplary embodiments will also be described in the context of particular methods having certain steps. However, the method and system operate effectively for other methods having different and/or additional steps and steps in different orders that are not inconsistent with the exemplary embodiments. Thus, the present invention is not intended to be limited to the embodiments shown, but is to be accorded the widest scope consistent with the principles and features described herein.

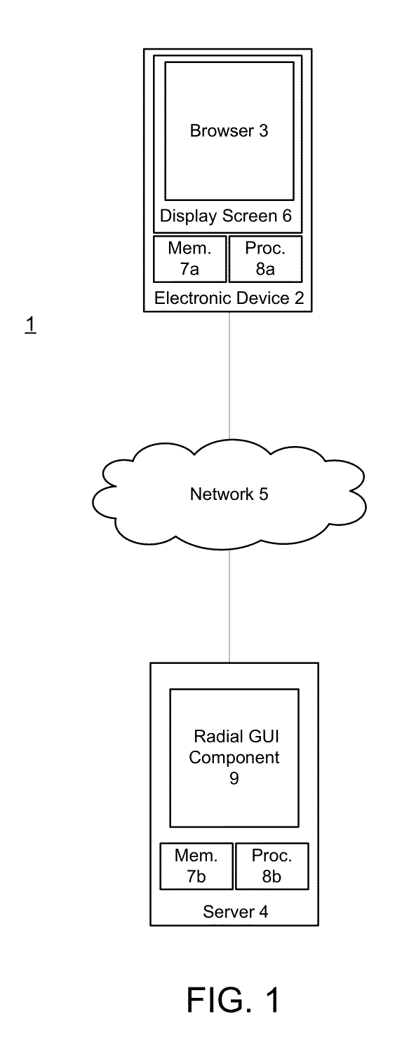

FIG. 1 is a block diagram illustrating an exemplary system environment in which one embodiment of the present invention may be implemented. The system 1 may include at least one electronic device 2 executing a browser 3 that is in communication with a server 4 over a network 5, such as the Internet. The electronic device 2 may comprises any type of computer, laptop, tablet, smart phone, set-top box, television or game console is capable of displaying information on a display screen 6. In this example, the electronic device 2 is shown displaying the browser 3 on a display screen 6, which may be integrated with the electronic device 2 or remotely coupled to the electronic device 2. In one embodiment, the display screen 6 may be implemented as a touchscreen. Both the electronic device 2 and the server 4 may include components typical of a computing and communication device, including at least one computer-readable memory 7a and 7b and at least one processor 8a and 8b. Both the electronic device 2 and the server 4 may also include various communication components, such as wired and/or/wireless network adapters and input/output (I/O) devices (not shown).

Using the browser 3, the user may navigate to the uniform resource locator (URL) of a search engine to access the server 4 to perform Internet searches, for example. The effectiveness of a search process conducted via a conventional search engine, such as Google or Yahoo!, often depends on the prior knowledge of the user. That is, the more the user understands what is being searched for, the more effective the search activity can be.

The exemplary embodiments provide a method and system by which a user can increase the effectiveness of a search activity. In brief, the exemplary embodiments provide a radial graphical user interface (GUI) component 9 executing on the server 4 that presents search results from multiple search engines in a radial array that enables the user to more easily obtain and view the search results.

Although the radial GUI component 9 is shown executing on the server 4, the radial GUI component 9 may also be implemented as a browser plug-in and/or a separate application that executes on electronic device 2. In addition, functions of the radial GUI component 9 GUI 16 may be implemented using a greater number of modules/components. In addition, the server 4 may be implemented as any number of separate server/computers, including Web servers, application servers, and database servers.

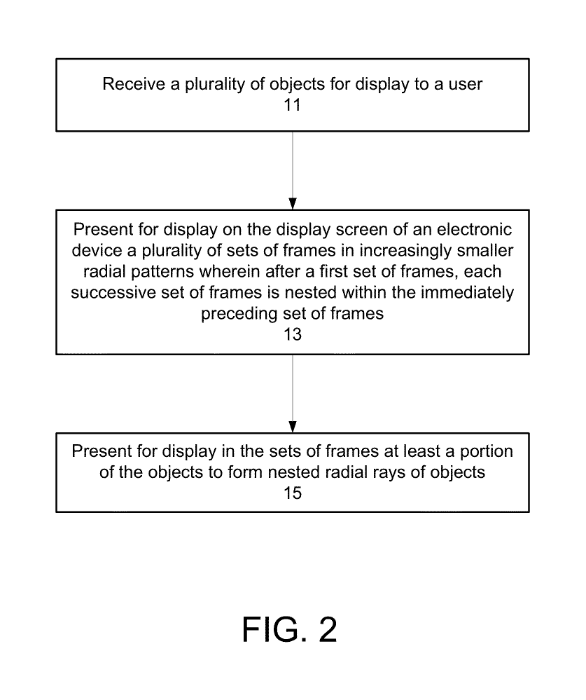

FIG. 2 is a flow diagram illustrating one embodiment of a process for graphical display of objects on an electronic device in a radial array. In one embodiment, the process is performed by the radial GUI component 9 executing on the server 4 for display of objects in a browser executing on the user's electronic device 2.

The process may begin by the radial GUI component 9 receiving a plurality of objects for display to a user (block 11). In one embodiment, the objects may comprise a collection of initial user search results. In one embodiment, the objects in the search results may comprise any combination of images, text, documents, or videos. For example, the objects may a plurality of images obtained from the home images of individual sites or results found during an Internet search. In one embodiment, the server 4 may perform the search, while in another embodiment, the server 4 may aggregate search results received from several different search engines, such as Bing, Yahoo, Google, Ask.com, and YouTube, and/or from e-commerce sites such as eBay and Amazon. In yet another embodiment, receiving the plurality of objects may refer to retrieving files locally from storage on the electronic device 2.

The radial GUI component 9 presents for display on a display screen of the electronic device a plurality of sets of frames in increasingly smaller radial patterns, wherein after a first set of frames, each successive set of frames is nested within an immediately preceding set of frames (block 13).

In one embodiment, the sets of frames may be displayed in a circular pattern or configuration. In another embodiment, the sets of frames may be displayed in an elliptical pattern or configuration. In another embodiment, the sets of frames may be displayed in a spiral pattern or configuration.

As used herein, the GUI component 9 presenting for display refers to the process of the radial GUI component 9 transmitting webpages in the form of HTML tags (or equivalents) and images (e.g., via the server 4) to the browser 3, which then reads the HTML tags and formats the webpages onto the display screen 6.

The radial GUI component 9 also presents for display in the sets of frames at least a portion of the objects to form nested radial arrays of objects (block 15). In one embodiment, the nested radial arrays of objects may comprise circular arrays. In one embodiment, the nested radial arrays of objects may comprise elliptical arrays. In another embodiment, the nested radial arrays of objects may comprise spiral arrays.

I. Circular Array

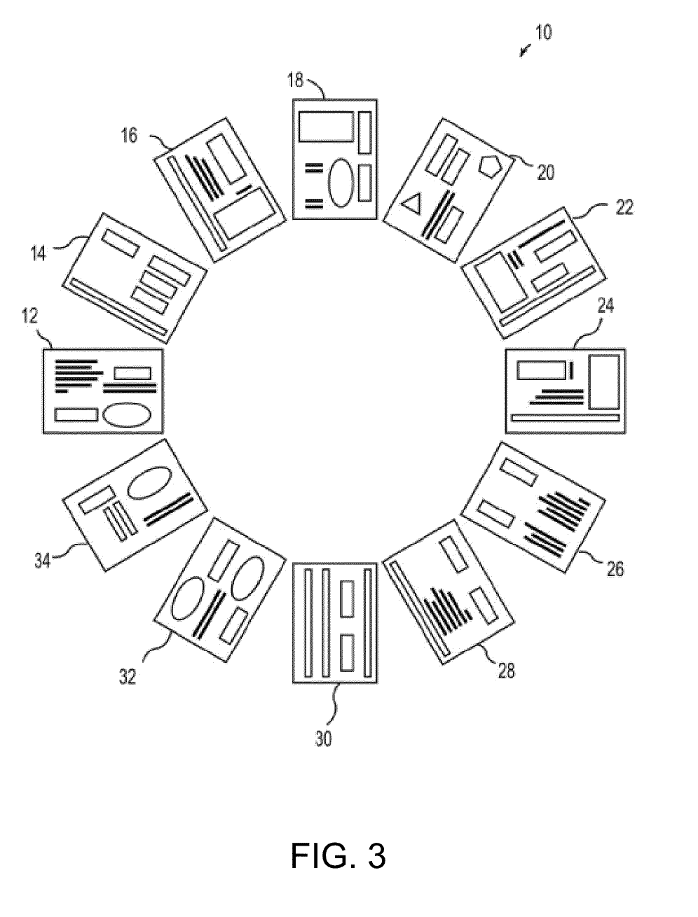

FIG. 3 is a diagram showing a collection of objects representing initial user search results displayed as a plurality of search result frames configured into a circular array 10. The circular array 10 may be presented on a communication device display, such as for example, a computer monitor, or a touch screen on a mobile device. The circular array 10 may be configured in a clockwise sense, as shown, from a first frame 12 to a twelfth frame 34, or in a counter-clockwise sense (not shown). The circular array 10 represents the results of an Internet search conducted by a user of the communication device.

The circular array 10 comprises a plurality of images obtained from the home pages of individual sites or results found during the Internet search. A homepage of the “best match” site, or most relevant site is displayed within the first frame 12. A homepage of the “next most relevant” match or “second best match” site is displayed within a second frame 14, and a homepage of the “next most relevant” match or “third best match” site is displayed within a third frame 16.

The number of frames that may be displayed, shown here as twelve frames 12 through 34 oriented along the radial lines of a circle, may be a function of the resolution of the particular display screen being accessed by the user of the communication device and may be more or fewer than twelve frames. These twelve frames may correspond to the first twelve best matches or most relevant sites found in the current search conducted by the user. In an exemplary embodiment, the user can access the first frame 12 to log in, and create or search for additional content, as described in greater detail below.

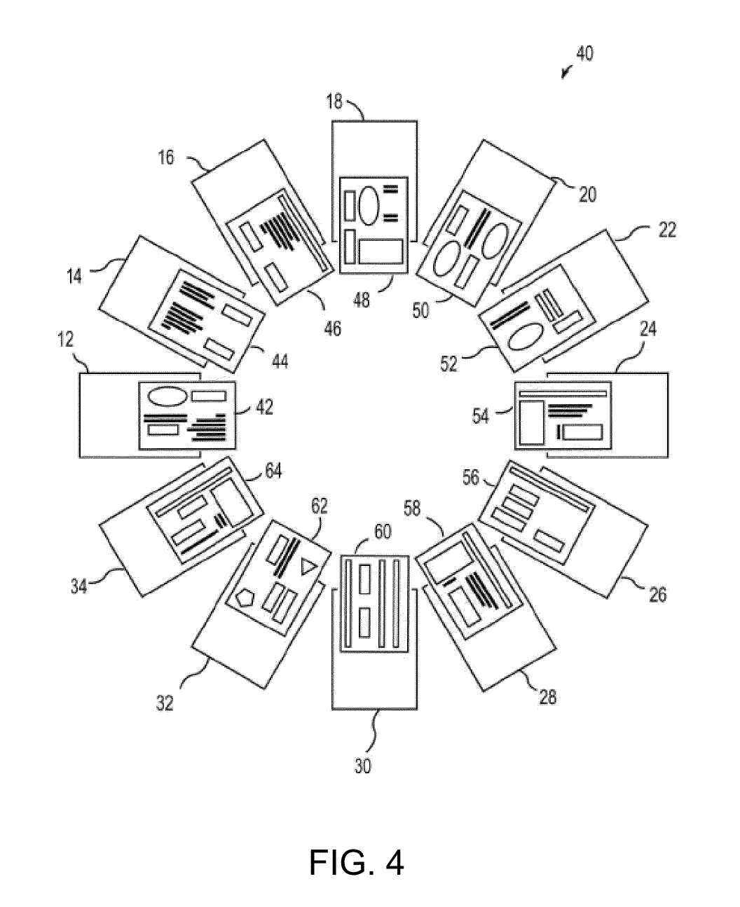

With further searching, the user may obtain additional search results to be displayed as a second plurality of search result frames 42 through 64, shown in a circular configuration nested inside the initial search results of frames 12 through 34, as shown in the diagrammatical illustration of FIG. 4. If any results appearing in the second plurality of search result frames 42 through 64 are identical to any of the search result frames in the initial plurality of search result frames 12 through 34, the duplicate results in the second set may be discarded and are replaced by subsequent search frames. This process may be continued until each circular array comprises unique search result frames.

The second set of twelve search result frames 42 through 64 comprise frames of a smaller size than the frames in the initial set of search result frames 12 through 34, and are also oriented along the radial lines of a circle. In addition, the second set of search result frames 42 through 64 partially overlap the initial set of search frames 12 through 34 to form a circular array 40 of two nested circular sets.

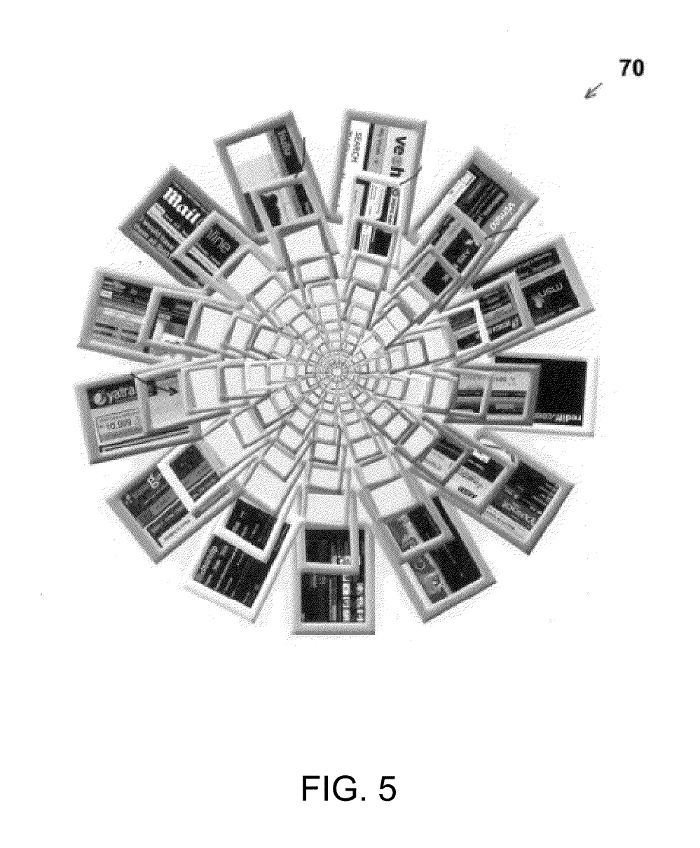

That is, frame 42 is smaller in size than frame 12, and frame 42 is positioned to partially overlap frame 42. Similarly, frame 44 is smaller than, and partially overlaps, frame 14, and so on to frame 64 which is smaller than, and partially overlaps frame 34. In an exemplary embodiment, shown in the pictorial illustration of FIG. 5, complete search results may produce a seemingly-endless plurality of circular arrays, wherein successively smaller circles of fourteen frames overlapping adjacent circles of fourteen frames to form an extended interior cylindrical surface 70.

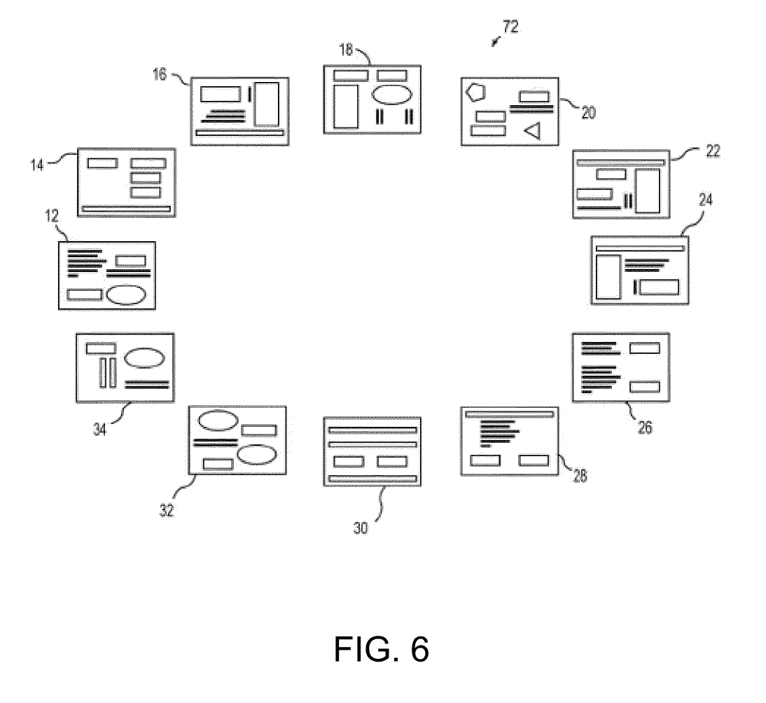

In an exemplary embodiment, shown in FIG. 6, the initial set of search results may be displayed as the frames 12 through 34 arranged as a generally elliptical array of frames 72, rather than in a circular pattern, thus allowing all the rectangular frames 12 through 34 to be oriented in the same direction. The second set of search results (not shown) can also be arranged in an elliptical pattern of frames to overlap the initial set of frames 12 through 34, in a manner similar to that used in the circular array 40, with the second set of search result frames overlapping the initial set of search result frames 12 through 34.

II. Spiral Array

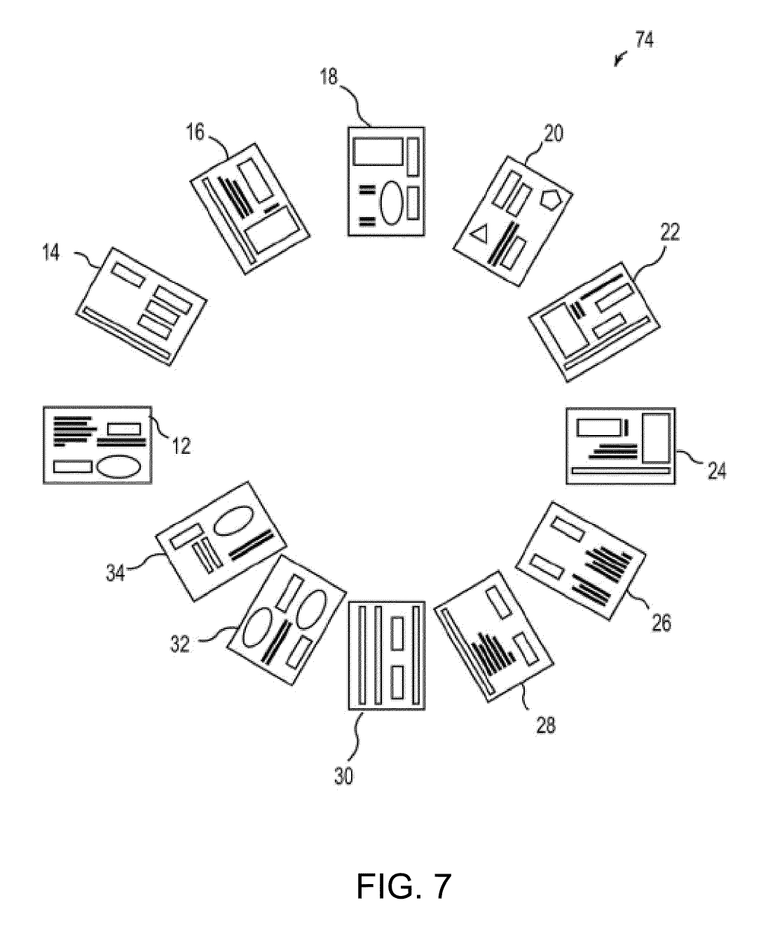

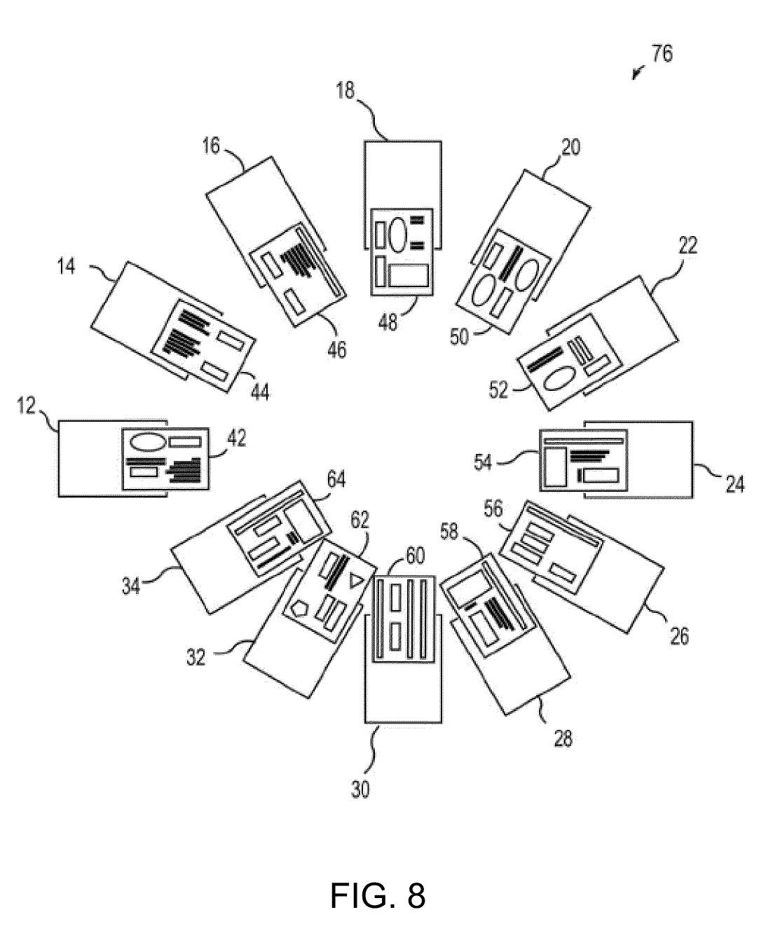

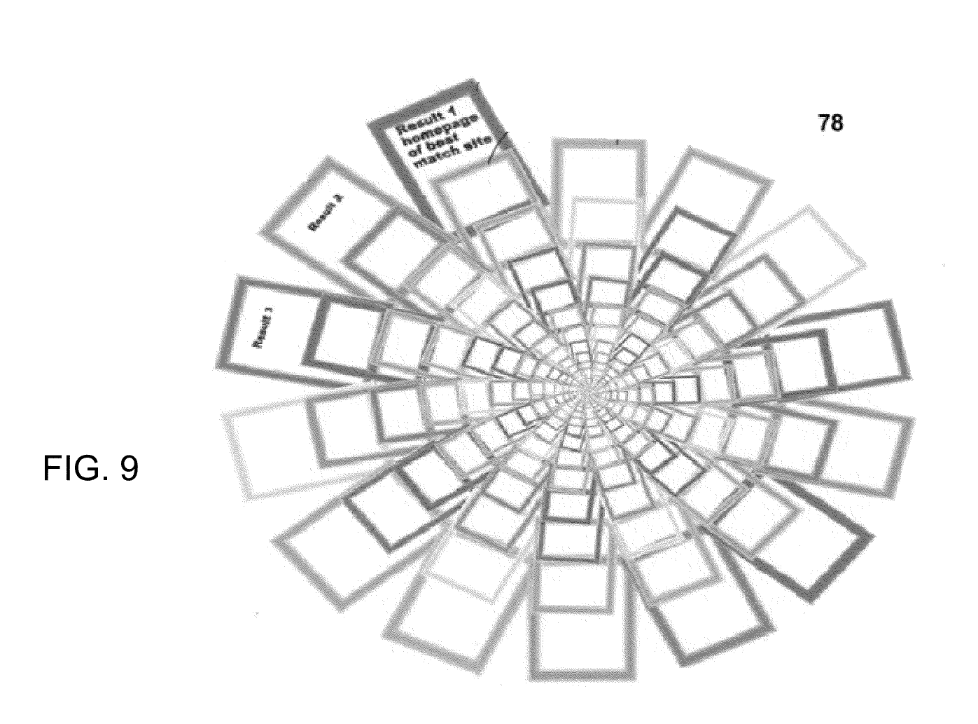

In an exemplary embodiment, shown in FIG. 7, the initial set of search results may be displayed as the frames 12 through 34 arranged in a generally closing spiral pattern 74, rather than in a circular or elliptical pattern. The second set of search result frames 42 through 64, can also be arranged in a spiral pattern to overlap the initial set of frames 12 through 34, as shown in the spiral array 76 of FIG. 8. In an exemplary embodiment, shown in the pictorial illustration of FIG. 9, complete search results may produce a seemingly-endless spiral array 78, wherein successively smaller groups of frames overlap adjacent groups of frames to form the spiral array 78.

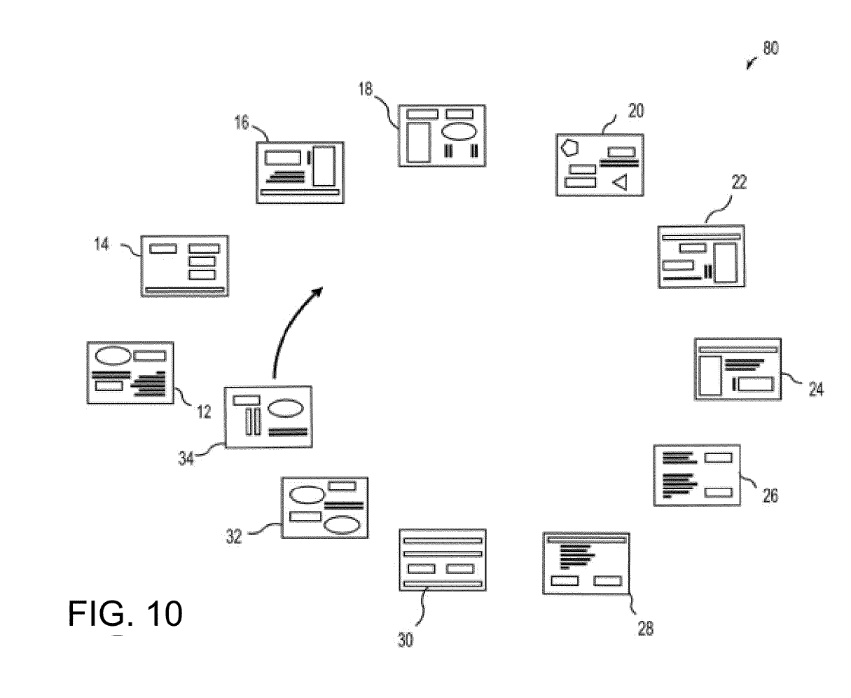

In an exemplary embodiment, shown in FIG. 10, the initial set of search result frames may be displayed as the frames 12 through 34 arranged as a generally elliptical spiral array of frames 80, rather than in the circular spiral pattern shown in FIG. 5. This elliptical format allows all the rectangular frames 12 through 34 to be oriented in the same direction. The second set of search result frames (not shown) can also be arranged in an elliptical pattern to overlap the initial set of frames 12 through 34, in a manner similar to that used in the spiral array 40, with the second set of search result frames 42 through 64 overlapping the initial set of search result frames 12 through 34.

III. User Navigation

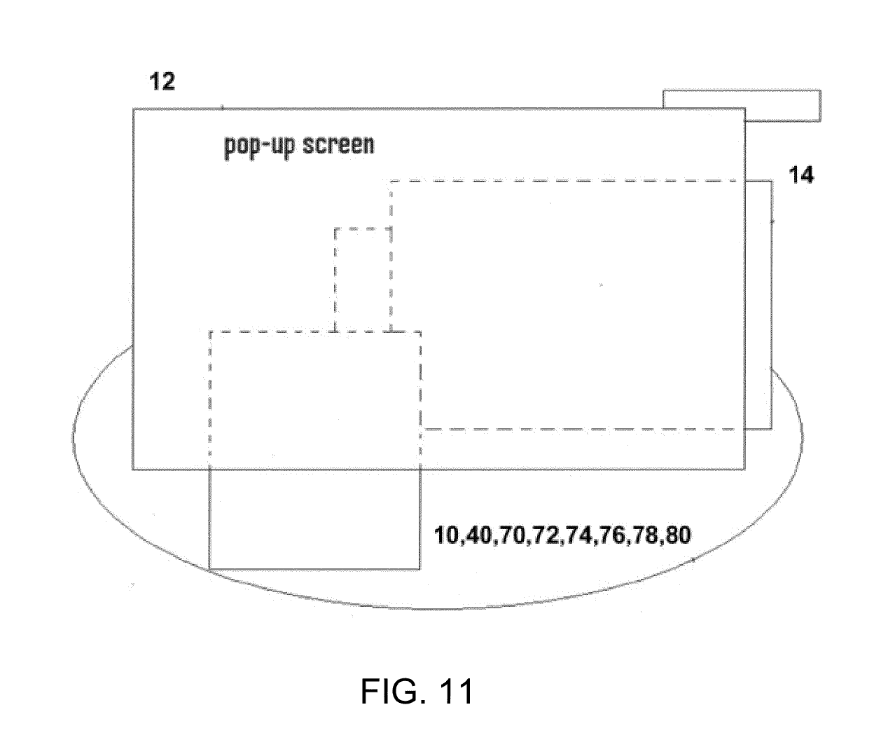

In an exemplary embodiment, shown in FIG. 11, the user has selected for review the first frame 12 from any one of the arrays 10, 40, 70, 72, 74, 76, 78, or 80. In response, the object displayed in the first frame 12 may be enlarged and positioned centrally in the field of the display, while in one embodiment, the array 10, 40, 70, 72, 74, 76, 78, or 80 may be “tilted away” from the user. The user may further select other frames, for example, the second frame 14, and “stack” the second frame 14 behind the first frame 12. Clicking a predefined key or performing a gesture, e.g., double tap, may remove display of the enlarged frames.

In an exemplary embodiment, in response user input, the user can move up and move down the circular rows, and along the spiral path. Moreover, in response to user input, the circular or spiral array may be rotated clockwise, or counter-clockwise.

In an exemplary embodiment, the user can move up and move down the circular rows, and along the spiral path. Moreover, the user can rotate the circular or spiral array clockwise (CW), or counter-clockwise (CCW). A particular frame can be moved to a different position within a circular row or along the spiral path. The user can access a Control Wheel (not shown) providing two root functions—‘click’ and ‘rotate’ CW or CCW. Click on the wheel will show the options: Row, Column, Frame alternatively. For example, when the user first clicks on the control wheel, a ‘row’ symbol appears on surface of the control wheel. When the user clicks again, a ‘column’ symbol appears. When the user clicks again, a ‘frame’ symbol appears, and so on.

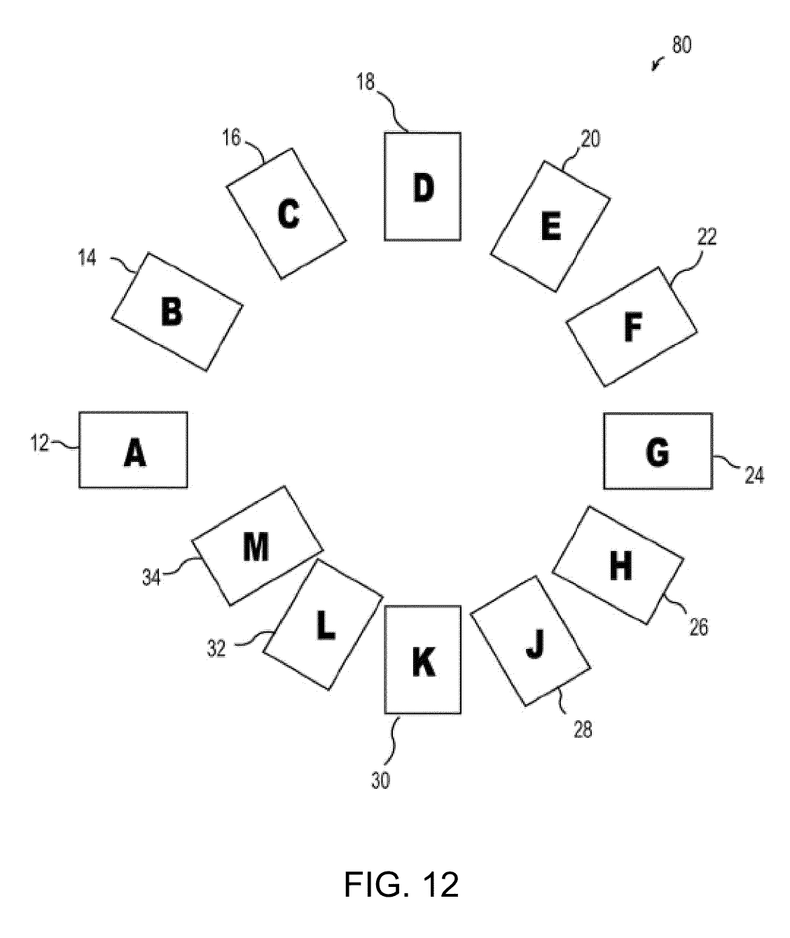

In an alternative embodiment, shown in FIG. 12, a spiral array of frames 80 may be adapted for a social networking application by displaying images of a user's friends. In one embodiment, the user's friends may be displayed according to geographical proximity to the user. For example, the first frame 12 (A) may show the user friend that is in closest geographic proximity, the second frame 14 (B) may show the user friend that is in next closest geographic proximity to the user, and so on. Moreover, when a user's friend is “online,” the respective friend's frame may “light up,” or give another visual indication of online activity.

In another embodiment, groups of users or teams of users may be displayed in the spiral array of frames. In yet a further embodiment, different groups of users may be displayed on respective levels or sets of frames in the spiral array.

When the frame showing one of the users is selected, the image of the user may be rotated so that the image is shown in the correct orientation despite its position in the spiral array. In another embodiment, information about the selected user may be displayed in a pop-up window or in the center of the spiral array.

In an alternative embodiment, the spiral array of frames 80 can be used to display search results and information according to the users' reference of time. For example, a new page or a news live video posted at 12 noon can be displayed in the top frame 18 (D), whereas a user friend's post at 3:00 pm can be placed on the rightmost frame 24 (G), at the 3 o'clock position. Each of the twelve frame 12 through 34 in the first spiral row, and each of the 12 frames of each interior spiral row in the spiral array 80 can thus be associated with clock positions. For example, information related to a user's 6:00 pm appointment may be displayed in the bottom frame 30 (K) associated with 6 o'clock position in FIG. 10.

In an alternative embodiment, the spiral array of frames 80 can be used to show a user interface system for an online marketplace application. Online postings of products on sale, or on a bidding process, may be displayed in accordance with the users' geographical preference. For example, products which are closer to the user are displayed in the center frames, as these represent lower shipping and transportation costs. In another alternative exemplary embodiment, the users' preference of time may be used to arrange the search results. For example, if a product listing expires at one o'clock, this listing will be displayed in the frame associated with the one o'clock position.

In an alternative embodiment, the spiral array of frames 80 can be used to show consumer preferences. It can be appreciated that many consumers' demands can be displayed for the suppliers to view in relation to the time of demand will expire, to the locations of the consumers in relation to each and many suppliers.

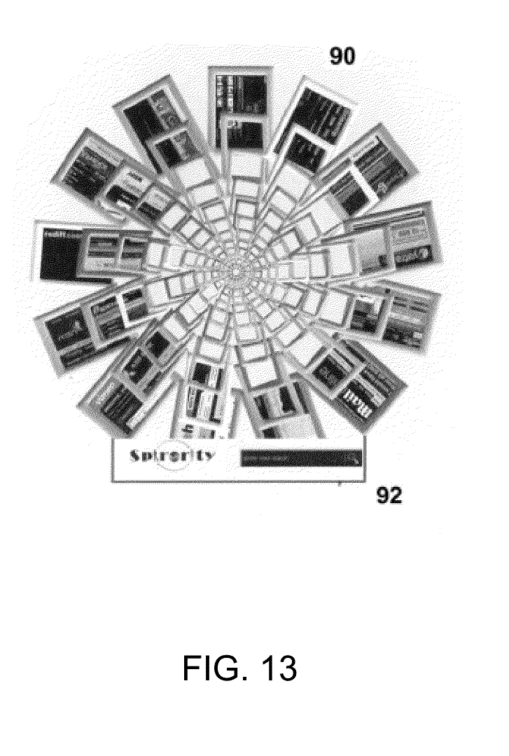

In an exemplary embodiment, shown in FIG. 13, the cylindrical array 70 of FIG. 3 may be modified to form a truncated cylindrical array 90. This configuration serves to accommodate a search window 92 adjacent a lower portion of the truncated cylindrical array 90. This configuration of the truncated cylindrical array 90 and the search window 92 may be particularly adaptable to a display device having a substantially square aspect ratio, or to a display device having a substantially circular shape.

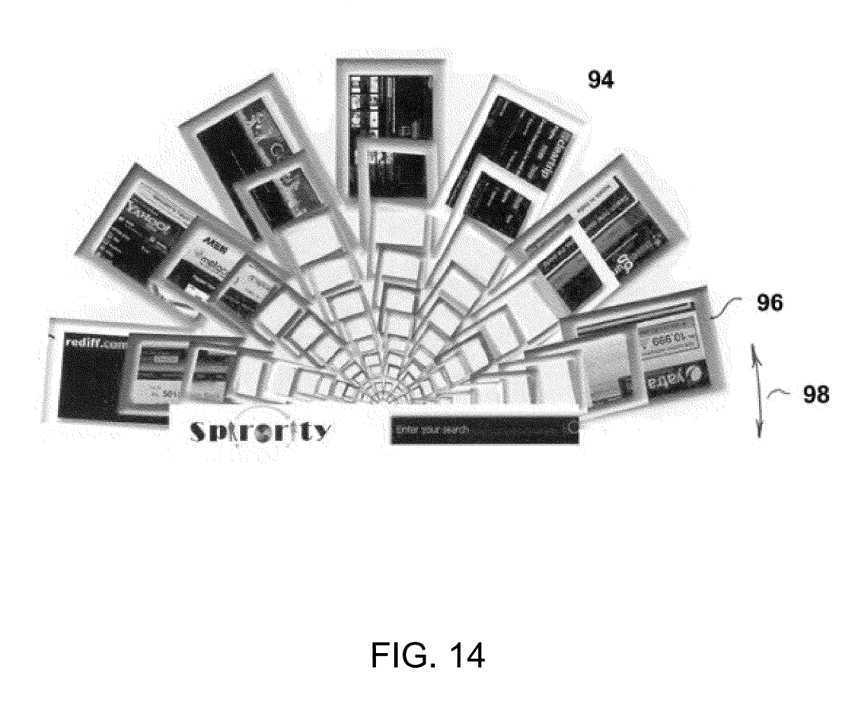

FIG. 14 is an illustration of an exemplary embodiment of a semicircular array 94 that includes a search window 98 disposed at a chord of an uppermost or outermost circle of frames in the semicircular array 94. The configuration shown may be particularly adaptable to a display device comprising a flexible or foldable screen (not shown). Preferably, the user may also be able to “rotate” the semicircular array 94, as indicated by arrow 96, to move a frame 92 “out of sight,” or “below the horizon,” by turning the semicircular array 94 clockwise or counterclockwise. This turning action would then bring one or more additional frames into view that had previously been out of sight.

Alternatively, such “hidden” frames may be presented on the other, underlying portion of a folded display screen, when used. For a folded screen, for example, the rotating action may function to move a particular frame, such as the frame 92, from the display area represented by FIG. 12 to the other, underlying portion of the folded display screen.

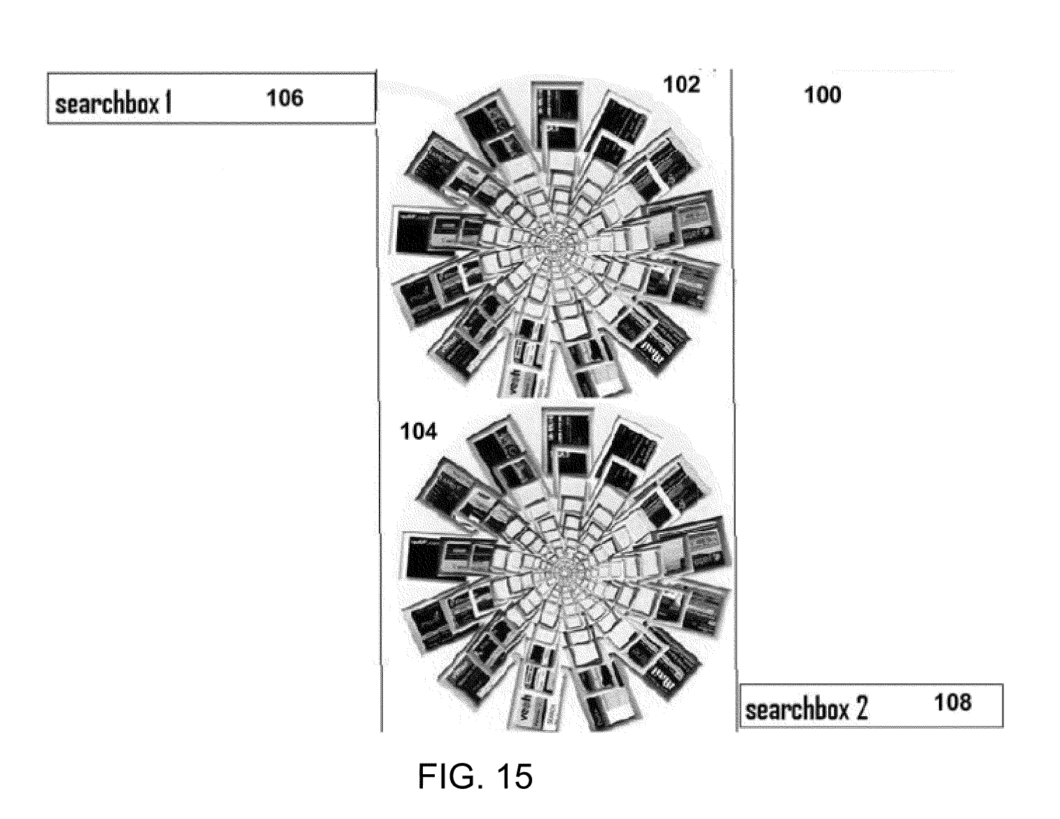

FIG. 15 is a pictorial illustration showing a display 100 including a first set of search results 102, a second set of search results 104, a first search box 106, and a second search box 108, that can be on the same screen with the spiral/circular frames, or can be on different screens on remote devices, connected by wired or wireless means to the device containing the spiral/circular frames. In an exemplary embodiment, the spiral/circular frames can be connected with the search boxes 106 and 108 which may show the information and details relates to each frame in the search results. Alternatively, the first search box 106 and the second search box 108 may display the description of the search results which appear on each frame.

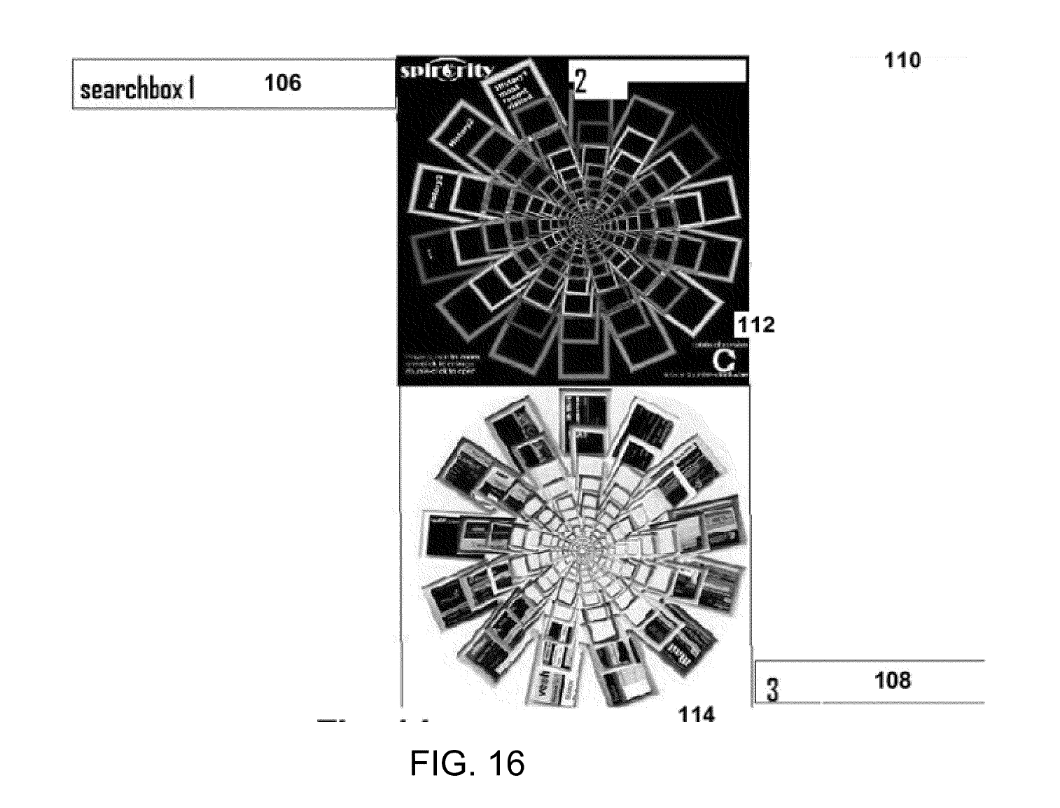

FIG. 16 is a pictorial illustration showing a display 110 including a first array of search results 112, a second array of search results 114, the first search box 106, the second search box 108, and a third search box 116.

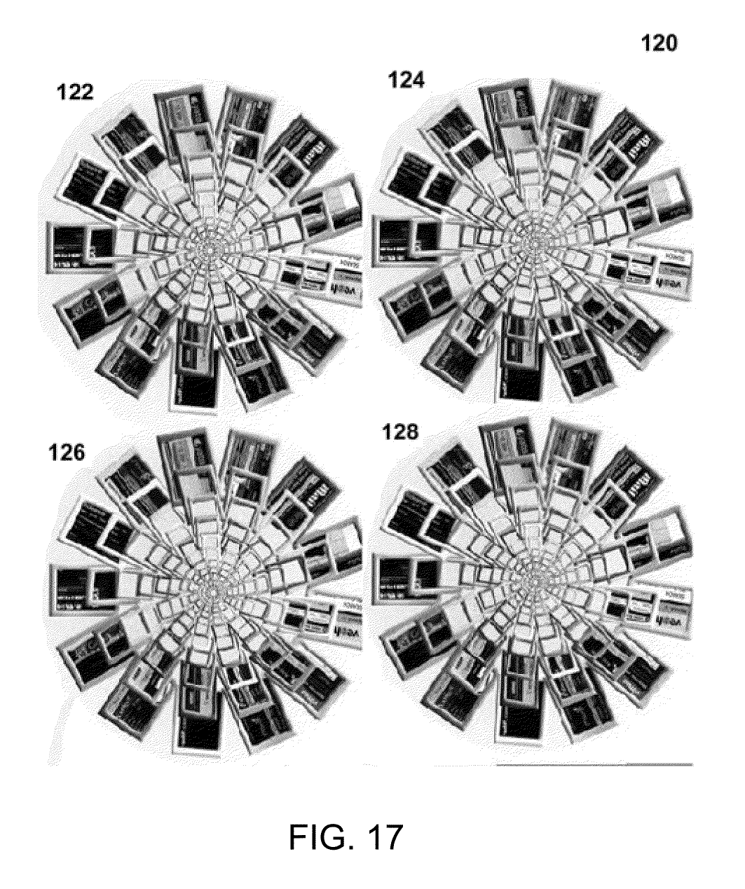

FIG. 17 is a pictorial illustration of a virtual classroom 120 providing users with a first search results array 122, a second search results array 124, a third search results array 126, and a fourth search results array 128.

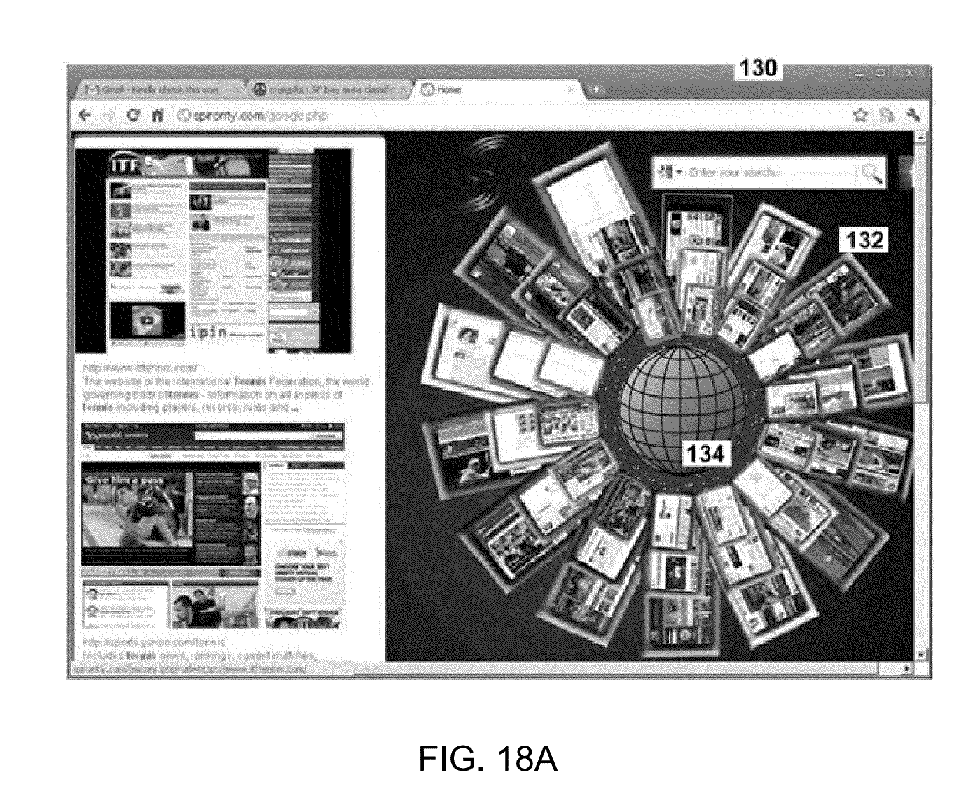

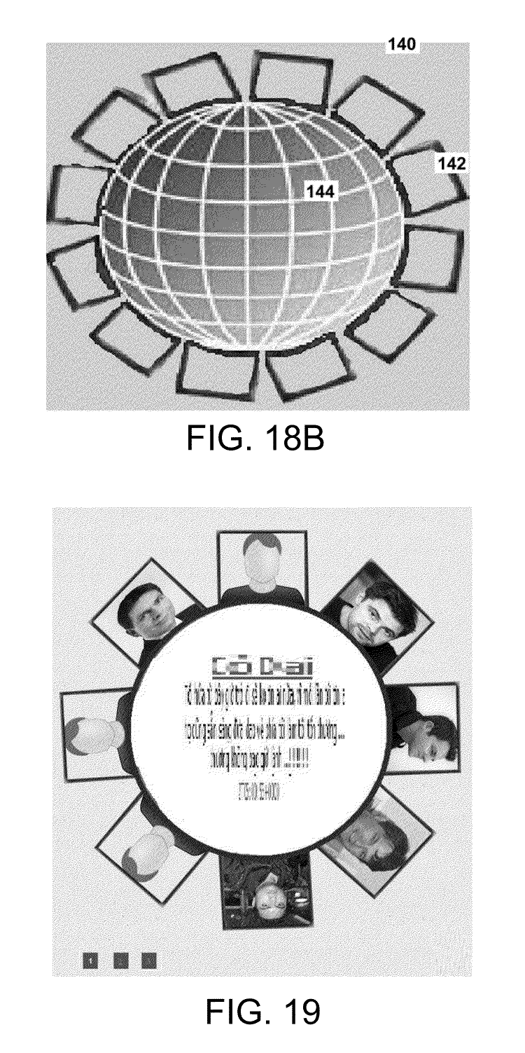

According to another aspect of the exemplary embodiment, an outer set of frames of the radial array while, an inner region of the radial array may be used to display content about the objects displayed in the frames of the radial array. In one embodiment, the content may comprise a control menu, which may be displayed with an icon, such as an interactive globe icon that provides, as shown in FIGS. 18 and 19.

FIG. 18A is a pictorial illustration of a three-dimensional search screen 130 showing an array of web page frames 132 enclosing an interactive globe icon 134, or other polygon (not shown). The interactive globe icon 134 provides control menu features at the center of a spiral array or a circular array system. The top search result may be positioned at the center of the interactive globe icon 134, closest to the user.

FIG. 18B is a diagrammatical illustration of an interactive three-dimensional (3D) globe 140 with a plurality of frames 142 provided around the interactive 3D globe 140, and a plurality of rectangular regions 144 on the surface of the 3D interactive globe 140. Each frame 142 includes an operational menu that a user can access to operate a display provided by the interactive 3D globe 140. A control menu is provided in the interactive 3D globe 140, where each rectangular region 144 provides at least one menu and operational instructions for a user to access in controlling the spiral array or a circular array system.

Alternatively, a rectangular region 144 may be configured to display a logo, a trademark, or other related information for a company or partner who advertise with the spiral array or a circular array system. It can be appreciated that each rectangular region 144 represents a source of data for the user. The source of data may comprise, for example, data from a social networking site, data from a marketplace site, data from a video site, or data from a music site. The user can use a touch function on a device screen to rotate the interactive 3D globe 140 in a desired direction. In an exemplary embodiment, the user can operate the interactive 3D globe 140 in accordance with the gravitational magnetic field of the earth and the solar system.

In one embodiment, where people comprising a group are displayed in the frames of the radial array, the content displayed in inner region of the radial array may include information about the group or a selected person in the group, as shown in FIG. 19. Similarly, where audio tracks of a music album are displayed in the frames of the radial array, the content displayed in inner region of the radial array may include information about the music album or a selected track in the music album.

In an exemplary embodiment, a user may input a keyword and a group keyword to a search system to retrieve top results appear. The user can then select one of these top results to continue examining and searching the web. For example, a user may retrieve a page (not shown) that belongs to the result the user selected. The user can highlight additional keywords found in this page, which are associated with an original keyword user input. The users can touch or click on this highlighted keywords to open a dialog box. This dialog box may have the functions to (i) define the meaning of these keywords to the user; (ii) define how the highlighted keyword is related to the original keyword; and (iii) be prompted to export the highlighted keyword to a search engine or to multiple search engines.

As the user is continuing to look for more information on the page of interest, new keywords may be searched on a search engine, or on multiple search engines. By putting a cursor on a frame, the user can view the selected frame as an enlarged thumbnail. Clicking on the selected frame opens up the site, and the site is stored in one frame within a user User History Database (UHD). The user may continue to select more keywords, continuing the similar process until the User History Database contains the results and information that the user has been looking for. The users can delete irrelevant results on the UHD, as desired.

IV. Ranking Web Pages—A

As indicated previously, retrieved search results/pages may be ranked using one or more criteria, and displayed such that a position of the search results/pages in the radial array indicates the rank of the search results/pages. The ranking criteria may include:

Consistency criterion: The results that appear consistently on the most popular search engines have a higher O-rank.

Link-juice criterion: The page linked to a more popular site has a higher D-rank than a page linked to a less popular site.

The Vibe criterion: The higher the site's vibe-score, the higher the 0 rank. The site's owner Vibe-Index, the color theme and design orientation, as well as the frequency of the embedded sound/music on the site are the main contributing factor for the site Vibe's score.

V-correlation criterion: The higher the correlation of the page's Vibe score to the user's vibe index, the higher the O-rank. The higher the correlation of the site/page owner Vibe-index to the user's vibe-index, the higher the O-rank. Thus, owner information on the page contributes to an O-rank.

Review criterion: More reviews do not constitute a higher O-rank. Quality reviews do. The contents of the review and the Vibe-index of the reviewers comprise the quality of a review. Low quality reviews lower the O-rank.

Historical perspective criterion. An older, active site may be ranked higher than a newer site.

Invisible's hand criterion or Higher-law criterion: Leaving, for example, 12% chances to the Higher-law, the factor that not is one of the above described. It means that the total probability distributions of all the known factors described above is not unity (or 100%). This Higher-law factor may contribute to 12% of the O-rank's probability distribution while the total known factors described above contribute to 88%, as an example.

V. Ranking Web Pages—B

A singular spiral and/or circular array system may be used to search for special discount or on-sale items. The highest percent of discounted price items may be shown on the first frame, with the second-highest percentage on-sale item shows on the second frame, and so on. The users can elect to search for a ‘deal’ on different stores or networks, and the best deals may be displayed in the first frame. The total price of the items also can be for display instead of highest percentage of discount. The lowest prices items may be displayed in the first frames.

Search results of the system may be displayed in a circular design in which each frame represents a position on a clock, where the item on the frames of the one o'clock column show that the items will expired in one hour, or in one minute, depending on the user's setting, and that, within the one o'clock column, the highest discounted items may be displayed on top.

A user can access the system for free and give away items, as well as to determine a resale price, and determine a profit before contacting the givers of the items. The user can also search for other users who posted wanted request for specific item on the market place. The location setting or the price setting can be set so that the result can be shown as the maximum price the items is wanted for, or the result can show the nearest location of the people who post. A list of wanted items may be provided according to certain geographical areas, such as by the user of postal or zip codes. Suppliers also can set the results of wanted items by time period, such as showing the most urgently desired items first, or showing the highest prices first.

A user can post a job wanted. Prospective employers can search for a job title and descriptions, and the closest matched candidates may be shown first on the frame. The most likely candidate may be displayed on the outside frame of the spiral array system. The resume details, related works, and candidate's Internet records can be show on the same column of frames.

VII. Ranking Web Pages—C

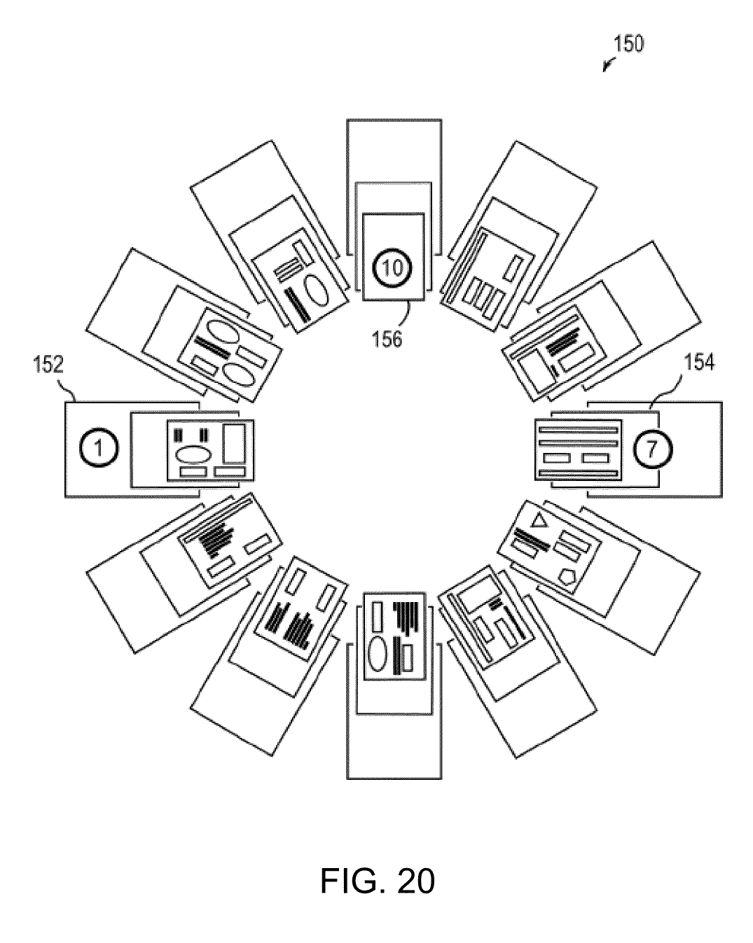

The disclosed method and system may function to provide a means of evaluating a particular web site. As shown in FIG. 20, a circular array 150 of search results provides the means to visually compare the rankings of a particular web page from different search engines. As shown in the diagrammatical illustration, the user has performed a web search using three different search engines. The same web page has turned up in search. When appearing in the search results using a first search, the web page may appear in the outermost ring of the circular array 150 as a web page 152. In the example provided, the web page 152 has been assigned a ranking of one (“1”), the highest ranking in the search results of the first search engine.

When appearing in the search results of the second search engine, shown in the second ring of the circular array 150, the same web page has been assigned a ranking of seven (“7”) as web page 154. And, when appearing in the search results of the third search engine, shown in the inner ring of the circular array 150, the same web page has been assigned a ranking of ten (“10”) as web page 156. This feature allows a user to gain a better assessment of the popularity of web page than if only one church provide were used to determine the ranking of the web page.

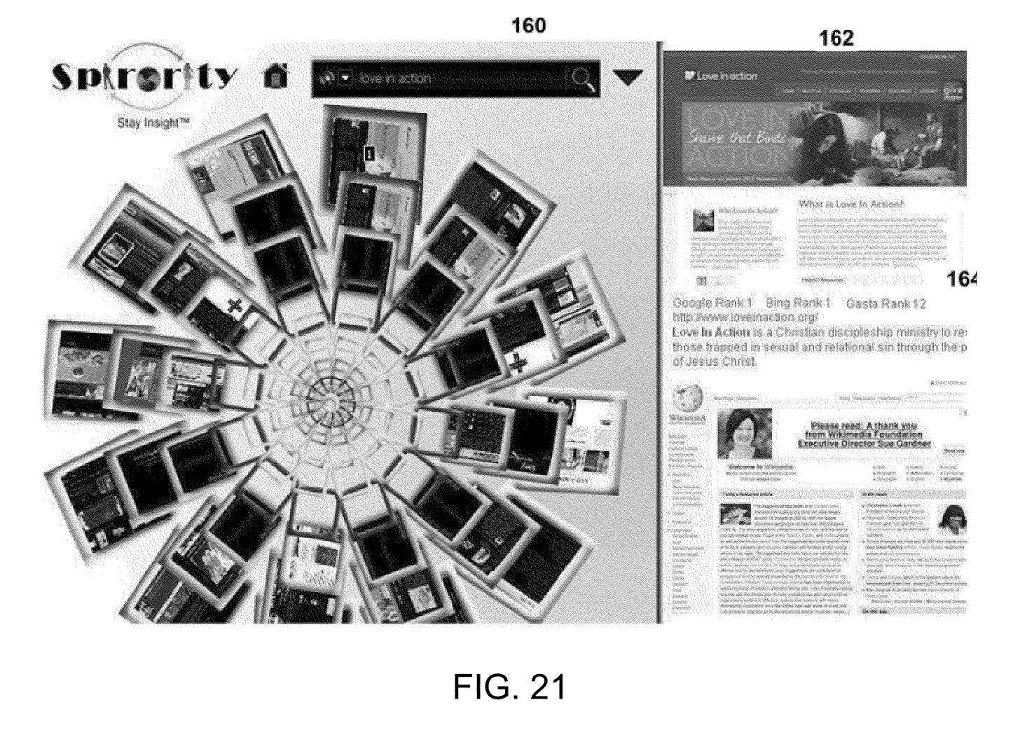

In an exemplary embodiment, shown in the pictorial illustration of FIG. 21, a ar array 160 of search results includes a side panel 162 which provides a textual comparison 164 ranking search results among multiple search engines. In the example provided, the textual comparison states that a particular web page was assigned a rank of one (“1”) in a Google search, a rank of one (“1”) in a Bing search, and a rank of twelve (“12”) in a Gasta search.

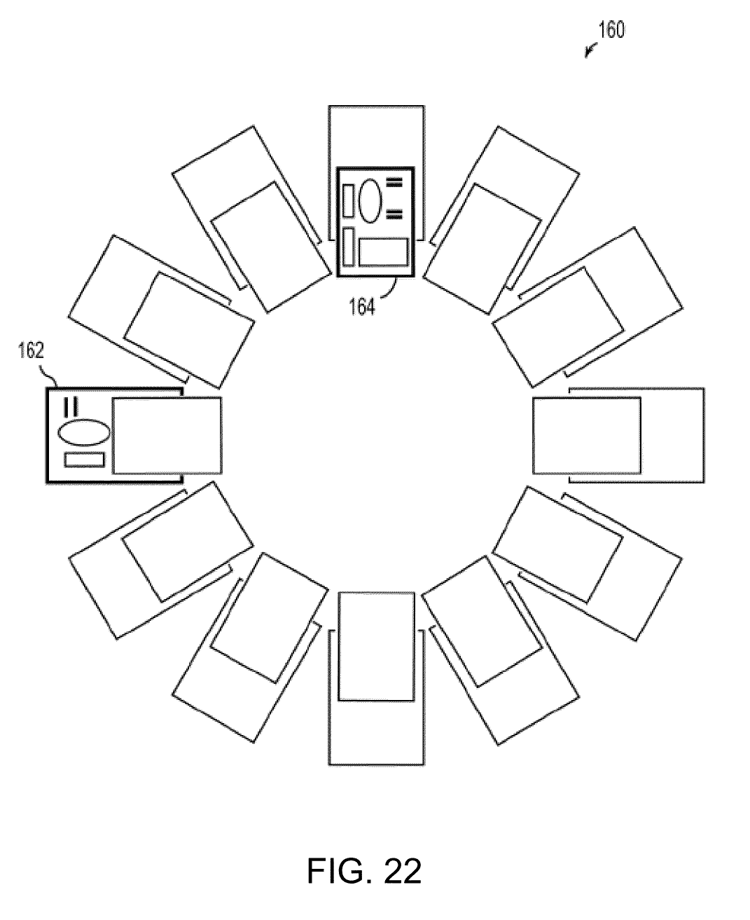

In an alternative embodiment, shown in the diagrammatical illustration of FIG. 22, a circular array 160 of search results includes the same web page found using two different search engines. In this example, search results from a first search engine, displayed in the outer ring of the circular array 160, include a web page 162. The web page 162 also as a web page 164 in the inner ring, which displays search results from a second web browser. In accordance with an embodiment of the present invention, the web page 162 and the web page 164 enter a blinking or flashing mode to visually indicate to the user that both search engines have retrieved the same web page. As can be appreciated by one skilled in the art, the blinking/flashing feature also provides a quick indication of the relative rankings of the same web page in the different web browsers. In the example provided, the first web browser has ranked the web page 162 higher than the web page 164 has been ranked in the second web browser.

VIII. Radial GUI as a Browser Application

When a user enters a web address into a traditional browser, the browser only opens up the homepage. It is then up to the user to navigate to the inner pages to view the content. More often than not the desired content may be hidden inside these inner pages.

According to one exemplary embodiment, the radial GUI component 9 may be configured to alleviate this problem by displaying the inner pages of a website in the radial array in response to the user and putting a web address.

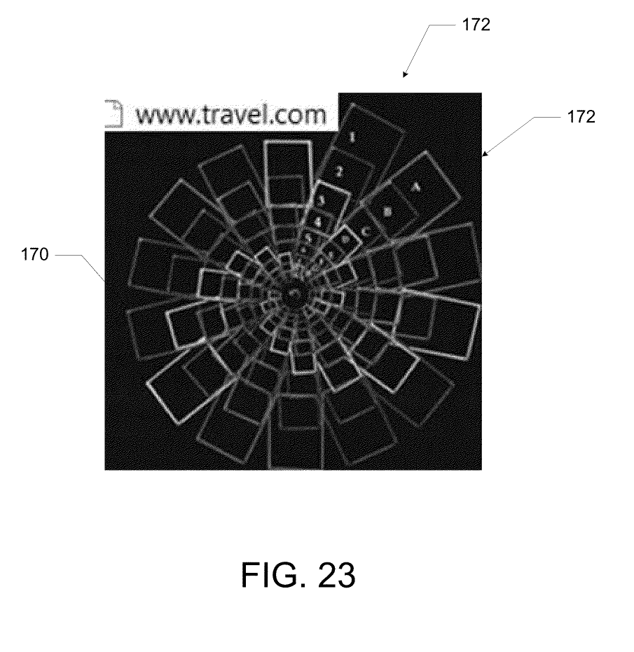

FIG. 23 is a diagram illustrating an example in which the user has input a search term “travel” into a browser's search field. In this embodiment, the homepage for the travel sites returned from search are displayed in frames formed along radial columns of the radial array 170, rather than around the rows or sets of frames comprising the radial array. In the example shown, the top ranked travel site's homepage may be displayed in frame 1 of column 172, while inner pages of the travel site are displayed along the same radial column in frame 2, 3, 4 and so on. The webpages of the next highest ranked travel site may be displayed in the next radial column 174 of the radial array 170 in frames A, B, C and so on.

Then the radial GUI component 9 may be configured to track the time and the frequency of clicks and views of each page in the radial array 170. The next time the same users visit the web pages, the webpages that user spends most time viewing based on time or frequency of viewing may be displayed in the first frame of the radial column, rather the homepage.

In one embodiment, users can select to add the radial GUI component 9 to their existing browser so that when viewing a given webpage, a radial GUI add-on application can help users to be more informed about the webpages. Information such as how many other online viewers, traffic and history of the viewing pages, etc., may be displayed.

In other embodiments, the frames can be as the same color of the background, so that only the objects are shown, while empty frames are invisible. In an alternative embodiment, the edges of the frame can be placed adjacent to each other so that the displayed objects not partially overlap each other. In one embodiment, the object in each frame can be auto rotated or manually rotated so that the object is not upside-down or sideways.

In a further embodiment, the radial array may be combined with other forms of display such as a slider, iframe, and the like.

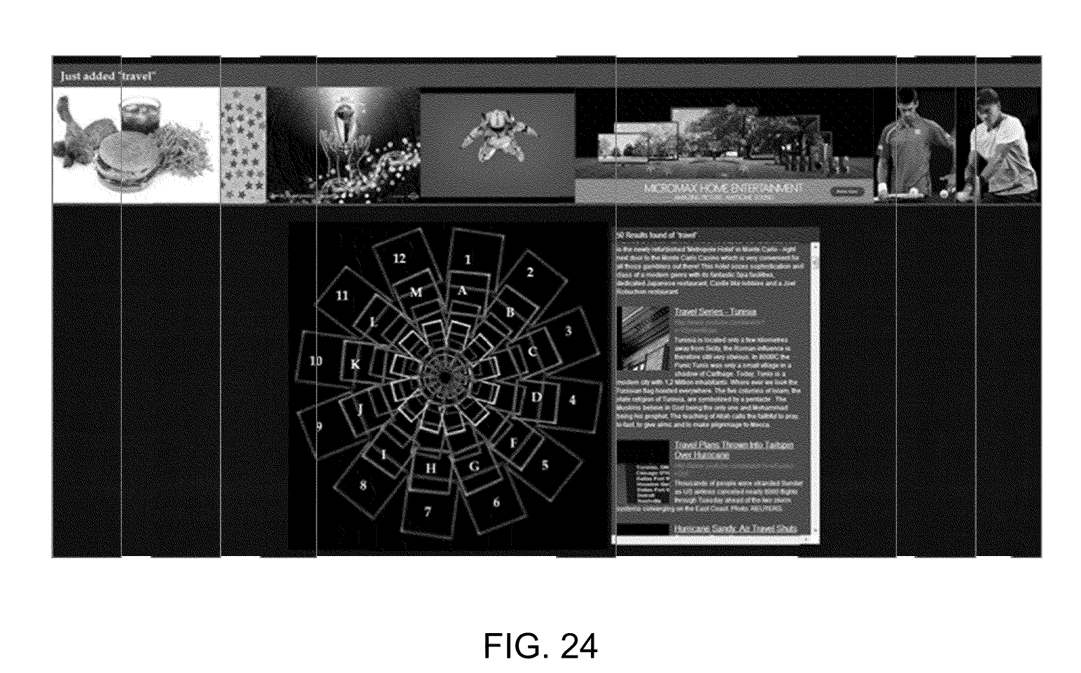

FIG. 24 is a diagram illustrating the radial array combined with a horizontal slider displaying images, and an iframe displaying text content adjacent to the radial array. Such a combination may minimize the need for the user to scroll down web pages to view search results and maximizes the amount of information that may be displayed on webpage. In particular, if the objects in the top slider are real-time, instant live-feeds, then users can always see the most up-to-date feed on the top slider.

IX. Symbolic Language

According to a further aspect of the exemplary embodiment, the radial GUI component 9 may be configured to receive search terms in the form of symbolic keywords defined by a symbolic language, the symbolic keywords comprising at least one of preset icons or pictures created with user gestures. At least a portion of the results returned from the search may then be displayed in the frame of the radial array. The symbolic keywords comprising the symbolic language may also be used for other uses, such as for texting and other forms of communication.

Thus, the exemplary embodiment enables the use of symbols and pictures to initiate searching activity. The user may draw symbolic keywords using fingers or a pen/brush-like device on a touch screen or in touch search box. The symbolic language can help to solve a language barrier where a user wants to perform an Internet search in a foreign country in which she does not know the language. The exemplary bottle, the user may still invoke a search by selecting preset icons or by drawing a picture of the item to be searched. The menu of the preset icons may be displayed to the user. The user can then swipe or select the desired icon e.g., a hamburger.

This system of using symbolic keywords for communication may be referred to as a Symbolic Language System (SLS). A further embodiment, the SLS may incorporate colors to add to or narrow the search terms. For example, the following selection of colors with associated meanings may be incorporated into search the search displays and activities described above: (i) Black—dark, ignorant, night, etc.; (ii) White: light—enlightened, day, etc.; (iii) Green—Go, flow, trees, etc.; (iv) Yellow—Attention, transition, masculine; (v) Red—Stop, war; (vi) Blue—Sky, Peace, Heaven; (vi) Brown: Earth; and (vii) Purple—Feminine, understanding, etc.

In another exemplary embodiment, SLS may be used with integrated sounds or music theory. Minor and major sound reflects the dark/bright, sad/happy nature. It can be represented by a distance of a third for Major and a second for Minor. A symbol of a white note next to a black note could represent a minor, while a white-black-white keys together represents a major.

As an example of this process, the keyword ‘Bicycle’ is drawn by two circles that connect with a line on top, and then inserting into a search box. The user uses a preferred color and hit search. Only a similarly-colored bicycle will be indexed and shown. If the user wants an electric bicycle, he may then add an electrical icon next to the ‘bicycle’ symbol. While drawing the two wheels, the system suggests to the user other options, such as a motorcycle, a tricycle, or a magnetic wheel bicycle. The user can learns these new groups of vocabularies during a search process for future uses. This example illustrates learning and using the system become an “interrelated,” “interconnected,” and a natural process.

In addition, placing a dollar symbol ($) next to the “bicycle” symbol may indicate that the user wishes to show the bicycle market-price. A plus-dollar symbol (+$) may means that the user wants to sell, a minus dollar symbol (−$) may indicate that the user wishes to make a purchase. A tool symbol next to two circles and a line would replace all the lengthy keyword “information on how to fix a bicycle.” The users from various languages with wide range of ages can make use of such a system. It is more fun, imaginative, and artistic than conventional methods of searching web pages. Further, the user may save time with this system in comparison to the method of typing keywords. If users prefer certain symbols over other symbols, as shown through repeated use, then the radial GUI component may display of symbols as default universal symbols.

A method and system for graphical display of objects has been disclosed. The present invention has been described in accordance with the embodiments shown, and there could be variations to the embodiments, and any variations would be within the spirit and scope of the present invention. For example, the exemplary embodiment can be implemented using hardware, software, a computer readable medium containing program instructions, or a combination thereof. Software written according to the present invention is to be either stored in some form of computer-readable medium such as a memory, a hard disk, or a CD/DVD-ROM and is to be executed by a processor. Accordingly, many modifications may be made by one of ordinary skill in the art without departing from the spirit and scope of the appended claims.

We claim:

1. A computer-implemented method for graphical display of objects, the method performed by software component executing on at least one processor, the method comprising:
receiving a plurality of objects for display to a user;
presenting for display on a display screen of an electronic device a plurality of sets of frames in increasingly smaller radial patterns, wherein after a first set of frames, each successive set of frames is nested within an immediately preceding set of frames; and
presenting for display in the sets of frames at least a portion of the objects to form nested radial arrays of objects.

2. The method of claim 1 further comprising displaying the plurality of sets of frames in increasingly smaller circular or elliptical patterns.

3. The method of claim 1 further comprising displaying the plurality of sets of frames in increasingly smaller spiral patterns.

4. The method of claim 1 further comprising displaying the frames in each of the successive set of frames smaller in size than the frames in a preceding set of frames.

5. The method of claim 1 wherein the frames in each of the successive sets of frames partially overlap with the frames in an immediately preceding set of frames.

6. The method of claim 1 wherein the objects comprise search results, the method further comprising displaying the search results such that a position of the search results in the frames indicates a rank of the search results.

7. The method of claim 5 wherein the objects comprise a plurality of images obtained from home pages of individual sites found during an Internet search, the method further comprising displaying a homepage of a most relevant site within a first frame in the first set of frames; displaying a homepage of a second most relevant site within a second frame; and displaying a homepage of a third most relevant match within a third frame.

8. The method of claim 5 further comprising displaying the search results from a first search engine in the first set of frames in the radial array, displaying the search results from a second search engine in a second set of frames in the radial array, and displaying search results from a third search engine in an inner set of frames in the radial array.

9. The method of claim 5 further comprising displaying webpages of a site returned from the search in frames formed along a radial columns of the radial array.

10. The method of claim 1 wherein the objects comprise images of a user's friends from a social networking application.

11. The method of claim 1 wherein the objects comprise search results and information displayed according to a users' reference of time.

12. The method of claim 1 further comprising responsive to a user selection of a first frame, enlarging an object displayed in the first frame and positioning the object centrally in a field of the display screen.

13. The method of claim 1 further comprising responsive to user input, rotating the radial array clockwise or counter-clockwise.

14. The method of claim 1 further comprising displaying the objects in an outer set of frames of the radial array and displaying in an inner region of the radial array content about the objects displayed in the outer set of frames.

15. The method of claim 1 further comprising: receiving search terms in a form of symbolic keywords defined by a symbolic language, the symbolic keywords comprising at least one of preset icons and pictures created with user gestures; and displaying at least a portion results of the search in the frames.

16. An executable software product stored on a computer-readable medium containing program instructions for graphical display of objects, the program instructions for:
receiving a plurality of objects for display to a user;
presenting for display on a display screen of an electronic device a plurality of sets of frames in increasingly smaller radial patterns, wherein after a first set of frames, each successive set of frames is nested within an immediately preceding set of frames; and
presenting for display in the sets of frames at least a portion of the objects to form nested radial arrays of objects.

17. The executable software product of claim 16 further comprising program instructions for displaying the plurality of sets of frames in increasingly smaller circular or elliptical patterns.

18. The executable software product of claim 16 further comprising program instructions for displaying the plurality of sets of frames in increasingly smaller spiral patterns.

19. The executable software product of claim 16 further comprising program instructions for displaying the frames in each of the successive set of frames smaller in size than the frames in a preceding set of frames.

20. The executable software product of claim 16 wherein the frames in each of the successive sets of frames partially overlap with the frames in an immediately preceding set of frames.

21. The executable software product of claim 16 wherein the objects comprise search results, the executable software product further comprising program instructions for displaying the search results such that a position of the search results in the frames indicates a rank of the search results.

22. The executable software product of claim 21 wherein the objects comprise a plurality of images obtained from home pages of individual sites found during an Internet search, the executable software product further comprising program instructions for displaying a homepage of a most relevant site within a first frame in the first set of frames; displaying a homepage of a second most relevant site within a second frame; and displaying a homepage of a third most relevant match within a third frame.

23. The executable software product of claim 21 further comprising program instructions for displaying the search results from a first search engine in the first set of frames in the radial array, displaying the search results from a second search engine in a second set of frames in the radial array, and displaying search results from a third search engine in an inner set of frames in the radial array.

24. The executable software product of claim 21 further comprising program instructions for displaying webpages of a site returned from the search in frames formed along a radial columns of the radial array.

25. The executable software product of claim 16 wherein the objects comprise images of a user's friends from a social networking application.

26. The executable software product of claim 1 wherein the objects comprise search results and information displayed according to a users' reference of time.

27. The executable software product of claim 16 further comprising program instructions for responsive to a user selection of a first frame, enlarging an object displayed in the first frame and positioning the object centrally in a field of the display screen.

28. The executable software product of claim 16 further comprising program instructions responsive to user input for rotating the radial array clockwise or counter-clockwise.

29. The executable software product of claim 16 further comprising program instructions for displaying the objects in an outer set of frames of the radial array and displaying in an inner region of the radial array content about the objects displayed in the outer set of frames.

30. The executable software product of claim 16 further comprising program instructions for: receiving search terms in a form of symbolic keywords defined by a symbolic language, the symbolic keywords comprising at least one of preset icons and pictures created with user gestures; and displaying at least a portion results of the search in the frames.

31. A system, comprising:
a memory;
a processor coupled to the memory; and
a software component executed by the processor that is configured to:
receive a plurality of objects for display to a user;
present for display on a display screen of an electronic device a plurality of sets of frames in increasingly smaller radial patterns, wherein after a first set of frames, each successive set of frames is nested within an immediately preceding set of frames; and
present for display in the sets of frames at least a portion of the objects to form nested radial arrays of objects.

32. The system of claim 31 wherein the software component displays the plurality of sets of frames in increasingly smaller circular or elliptical patterns.

33. The system of claim 31 wherein the software component the plurality of sets of frames in increasingly smaller spiral patterns.

34. The system of claim 31 wherein the software component displays the frames in each of the successive set of frames smaller in size than the frames in a preceding set of frames.

35. The system of claim 31 wherein the frames in each of the successive sets of frames partially overlap with the frames in an immediately preceding set of frames.

36. The system of claim 31 wherein the objects comprise search results, and wherein the software component displays the search results such that a position of the search results in the frames indicates a rank of the search results.

37. The system of claim 36 wherein the objects comprise a plurality of images obtained from home pages of individual sites found during an Internet search, the software component displays a homepage of a most relevant site within a first frame in the first set of frames; displays a homepage of a second most relevant site within a second frame; and displays a homepage of a third most relevant match within a third frame.

38. The system of claim 36 wherein the software component displays the search results from a first search engine in the first set of frames in the radial array, displays the search results from a second search engine in a second set of frames in the radial array, and displays search results from a third search engine in an inner set of frames in the radial array.

39. The system of claim 36 wherein the software component displays webpages of a site returned from the search in frames formed along a radial columns of the radial array.

40. The system of claim 31 wherein the objects comprise images of a user's friends from a social networking application.

41. The system of claim 31 wherein the objects comprise search results and information displayed according to a users' reference of time.

42. The system of claim 31 wherein the software component is responsive to a user selection of a first frame to enlarge an object displayed in the first frame and position the object centrally in a field of the display screen.

43. The system of claim 31 wherein the software component is responsive to user input to rotate the radial array clockwise or counter-clockwise.

44. The system of claim 31 wherein the software component displays the objects in an outer set of frames of the radial array and displays in an inner region of the radial array content about the objects displayed in the outer set of frames.

45. The system of claim 31 wherein the software component receives search terms in a form of symbolic keywords defined by a symbolic language, the symbolic keywords comprising at least one of preset icons and pictures created with user gestures; and displays at least a portion results of the search in the frames.
